(19) United States
(12) Patent Application Publication
(10) Pub. No.: US 2024/0013047 A1
(43) Pub. Date: Jan. 11, 2024

(54) DYNAMIC CONDITIONAL POOLING FOR NEURAL NETWORK PROCESSING

(71) Applicant: Intel Corporation, Santa Clara, CA (US)

(72) Inventors: Dongqi CAI, Beijing (CN); Anbang YAO, Beijing (CN); Yurong CHEN, Beijing (CN); Xiaolong LIU, Beijing (CN)

(73) Assignee: Intel Corporation, Santa Clara, CA (US)

(21) Appl. No.: 18/252,231

(22) PCT Filed: Dec. 24, 2020
(86) PCT No.: PCT/CN2020/138906

§ 371 Date: May 9, 2023

(51) Int. Cl. G06N 3/08

(52) U.S. Cl. CPC G06N 3/08; G06V 10/7715

(57) ABSTRACT

Dynamic conditional pooling for neural network processing is disclosed. An example of a storage medium includes instructions for receiving an input at a convolutional layer of a convolutional neural network (CNN); receiving an input sample at a pooling stage of the convolutional layer; generating a plurality of soft weights based on the input sample; performing conditional aggregation on the input sample utilizing the plurality of soft weights to generate an aggregated value; and performing conditional normalization on the aggregated value to generate an output for the convolutional layer.

### CLAIM OF PRIORITY

This application claims, under 35 U.S.C. § 371, the benefit of and priority to International Application No. PCT/CN2020/138906, filed Dec. 24, 2020, titled DYNAMIC CONDITIONAL POOLING FOR NEURAL NETWORK PROCESSING, the entire content of which is incorporated herein by reference.

### FIELD

This disclosure relates generally to machine learning and more particularly to dynamic conditional pooling for neural network processing.

### BACKGROUND OF THE DISCLOSURE

Neural networks and other types of machine learning models are applied in varying problems, and in particular including feature extraction from images. DNN (Deep Neural Networks) may utilize multiple feature detectors to address complex images, which requires very large processing loads.

Convolutional layers in a convolutional neural network (CNN) summarize the presence of features in an input image. However, output feature maps are sensitive to the location of the features in the input.

An approach to address this sensitivity is to down sample the feature maps, thus making the resulting down sampled feature maps more robust to changes in the position of features in an image. Pooling layers provide for down sampling feature maps by summarizing the presence of features in patches of the feature map. Two common pooling methods are average pooling and max pooling that summarize the average presence of a feature and the most activated presence of a feature respectively.

### BRIEF DESCRIPTION OF THE DRAWINGS

So that the manner in which the above recited features of the present embodiments can be understood in detail, a more particular description of the embodiments, briefly summarized above, may be had by reference to embodiments, some of which are illustrated in the appended drawings. It is to be noted, however, that the appended drawings illustrate typical embodiments and are therefore not to be considered limiting of its scope. The figures are not to scale. In general, the same reference numbers will be used throughout the drawing(s) and accompanying written description to refer to the same or like parts.

FIG. 1 is an illustration of an apparatus or system including dynamic conditional pooling for convolutional neural networks, according to some embodiments;

FIGS. 2A and 2B illustrate an example of a convolutional neural network that may be processed utilizing dynamic conditional pooling, according to some embodiments;

FIG. 3 illustrates an overview of a dynamic conditional pooling (DCP) apparatus or module for deep feature learning, according to some embodiments;

FIG. 4 is an illustration of a soft agent for dynamic conditional pooling, according to some embodiments;

FIG. 5 illustrates conditional aggregation for dynamic conditional pooling, according to some embodiments;

FIG. 6 illustrates conditional normalization for dynamic conditional pooling, according to some embodiments;

FIG. 7 is an illustration of an example use case of dynamic conditional pooling, according to some embodiments;

FIG. 8 is a flowchart to illustrate dynamic conditional pooling, according to some embodiments; and

FIG. 9 is a schematic diagram of an illustrative electronic computing device to enable dynamic conditional pooling in a convolutional neural network, according to some embodiments.

### DETAILED DESCRIPTION

Implementations of the disclosure describe dynamic conditional pooling for neural network processing. In some embodiments, an application, system, or process is to provide a dynamic pooling apparatus, module, process for deep CNNs that is sample-aware and distribution-adaptive, the dynamic pooling being capable of preserving task-related information while removing irrelevant details.

Pooling of visual features is critical for deep feature representation learning, which is a core of deep neural network (DNN) engineering, and is a basic building block/unit for constructing deep CNNs. To address feature pooling, current solutions commonly combine the outputs of several nearby feature detectors by summarizing the presence of features in patches of the feature map. Such conventional processes suffer limitation in operations because all feature maps are usually pooled under a same setting.

Based on the manner of aggregating visual features, previous pooling solutions can be generally divided into three categories: (1) The first category aggregates features within pooling regions with equal importance using a predefined fixed operation, such as a sum, an average, a max, or a commutative combination of certain operations. These are generally the more efficient and commonly used pooling methods. (2) The second category considers the variances of features within patches by introducing different kinds of stochastics and attentions. This category of pooling processes introduces adaptiveness based on statistics of pooling patches and improves robustness over the first kind. (3) The third category uses external task-related supervision to guide the aggregation of features. These are designed and optimized for certain task and network architectures.

Current technologies generally aggregate several nearby features in patches of the feature map by treating all feature pixels equally, considering feature variances within the pooling regions, or introducing external task-related supervision. However, different image or video samples exhibit distinctive feature distributions at different stages of deep neural networks. Conventional technologies fail to take advantage of the distinctiveness of individual samples and individual feature distributions, ignoring the direct bridge between the entire input feature map and the local aggregation operation. Pooling module should be carefully designed to capture the discriminative properties of each sample and their feature distributions.

In some embodiments, a dynamic conditional pooling technology provides for augmenting deep CNNs for accurate visual recognition, the technology introducing conditional computing to overcome the disadvantages of those previous solutions. In some embodiments, a technology may include, but is not limited to, a set of learnable convolutional filters to dynamically aggregate feature maps, a follow-up dynamic normalization block to normalize the aggregated feature and a lightweight soft agent to regulate the aggregation, and normalization blocks conditioning on the input sample. In this manner, the dynamic conditional pooling technology provides for: (1) Dynamic pooling conditioning both on the input sample (sample-aware) and feature maps (distribution-adaptive) at the current layer; (2) Weighting individual feature pixels regarding a local map region by learnable compositive importance-unequal kernels; and (3) Normalizing the aggregated features conditioning on the input sample.

In some embodiments, the dynamic conditional pooling technology may be utilized to provide a powerful general design that can be readily applied to different visual recognition networks with significant improved accuracy. The technology may be utilized in, for example, providing a software stack for augmenting deep CNNs for accurate visual recognition, providing a software stack for the training or deployment of CNNs on edge/cloud devices, and implementing large-scale parallel training systems.

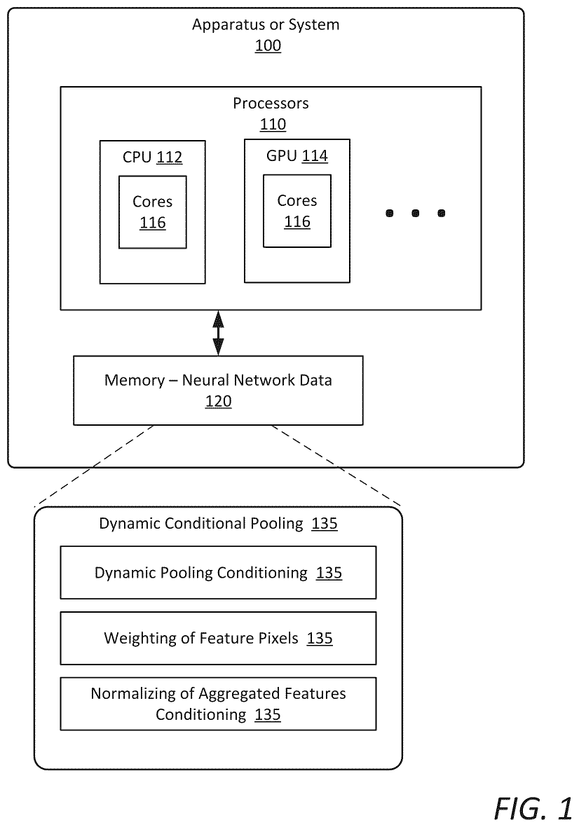

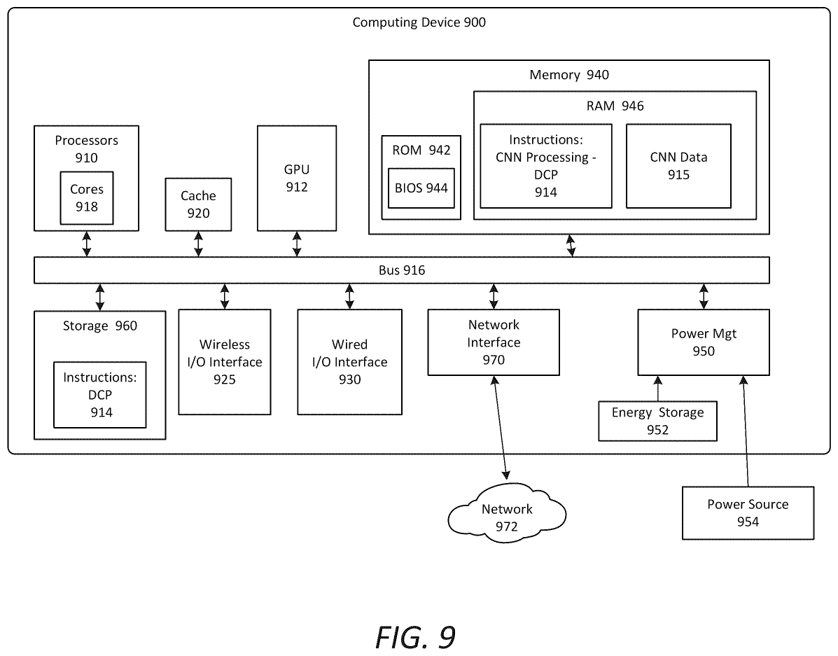

FIG. 1 is an illustration of an apparatus or system including dynamic conditional pooling for convolutional neural networks, according to some embodiments. In this illustration, a computing apparatus or system at least one or more processors 110, which may include any of, for example, central processing units (CPU) 112, graphical processing units (GPUs) 114, embedded processors, or other processors, to provides processing for operations including machine learning with neural network processing. The computing apparatus or system 100 further includes a memory to hold data for a deep neural network 125. Additional details for the apparatus or system are illustrated in in FIG. 9.

Neural networks, including feedforward networks, CNNs (Convolutional Neural Networks, and RNNs (Recurrent Neural Networks) networks, may be used to perform deep learning. Deep learning refers to machine learning using deep neural networks. The deep neural networks used in deep learning are artificial neural networks composed of multiple hidden layers, as opposed to shallow neural networks that include only a single hidden layer. Deeper neural networks are generally more computationally intensive to train. However, the additional hidden layers of the network enable multistep pattern recognition that results in reduced output error relative to shallow machine learning techniques.

Deep neural networks used in deep learning typically include a front-end network to perform feature recognition coupled to a back-end network which represents a mathematical model that can perform operations (e.g., object classification, speech recognition, etc.) based on the feature representation provided to the model. Deep learning enables machine learning to be performed without requiring hand crafted feature engineering to be performed for the model. Instead, deep neural networks can learn features based on statistical structure or correlation within the input data. The learned features can be provided to a mathematical model that can map detected features to an output. The mathematical model used by the network is generally specialized for the specific task to be performed, and different models will be used to perform different task.

Once the neural network is structured, a learning model can be applied to the network to train the network to perform specific tasks. The learning model describes how to adjust the weights within the model to reduce the output error of the network. Backpropagation of errors is a common method used to train neural networks. An input vector is presented to the network for processing. The output of the network is compared to the desired output using a loss function and an error value is calculated for each of the neurons in the output layer. The error values are then propagated backwards until each neuron has an associated error value which roughly represents its contribution to the original output. The network can then learn from those errors using an algorithm, such as the stochastic gradient descent algorithm, to update the weights of the of the neural network.

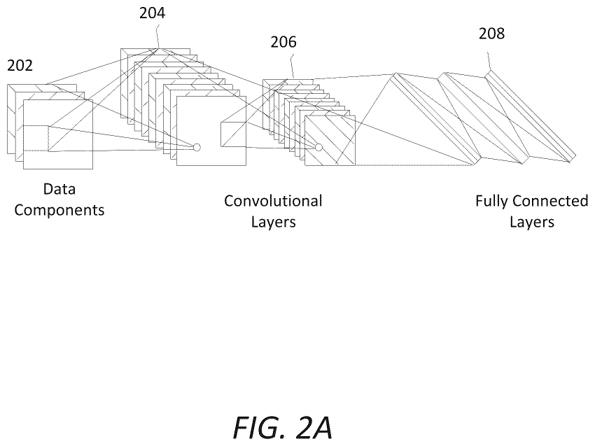

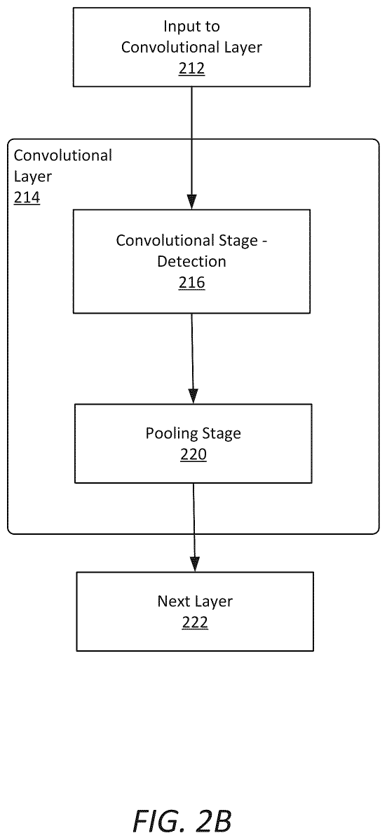

FIGS. 2A and 2B illustrate an example of a convolutional neural network that may be processed utilizing dynamic conditional pooling, according to some embodiments. FIG. 2A illustrates various layers within a CNN. As shown in FIG. 2A, an exemplary CNN used to, for example, model image processing can receive input 202 describing the red, green, and blue (RGB) components of an input image (or any other relevant data for processing). The input 202 can be processed by multiple convolutional layers (e.g., convolutional layer 204 and convolutional layer 206). The output from the multiple convolutional layers may optionally be processed by a set of fully connected layers 208. Neurons in a fully connected layer have full connections to all activations in the previous layer, as previously described for a feedforward network. The output from the fully connected layers 208 can be used to generate an output result from the network. The activations within the fully connected layers 208 can be computed using matrix multiplication instead of convolution. Not all CNN implementations make use of fully connected layers 208. For example, in some implementations the convolutional layer 206 can generate output for the CNN.

The convolutional layers are sparsely connected, which differs from traditional neural network configuration found in the fully connected layers 208. Traditional neural network layers are fully connected, such that every output unit interacts with every input unit. However, the convolutional layers are sparsely connected because the output of the convolution of a field is input (instead of the respective state value of each of the nodes in the field) to the nodes of the subsequent layer, as illustrated. The kernels associated with the convolutional layers perform convolution operations, the output of which is sent to the next layer. The dimensionality reduction performed within the convolutional layers is one aspect that enables the CNN to scale to process large images.

FIG. 2B illustrates exemplary computation stages within a convolutional layer of a CNN. Input to a convolutional layer 212 of a CNN can be processed in stages of a convolutional layer 214. The stages can include a convolution stage 216 and a pooling stage 220. The convolution layer 214 can then output data to a successive convolutional layer 222. The final convolutional layer of the network can generate output feature map data or provide input to a fully connected layer, for example, to generate a classification value for the input to the CNN.

In the convolution stage 216 several convolutions may be performed in parallel to produce a set of linear activations. The convolution stage 216 can include an affine transformation, which is any transformation that can be specified as a linear transformation plus a translation. Affine transformations include rotations, translations, scaling, and combinations of these transformations. The convolution stage computes the output of functions (e.g., neurons) that are connected to specific regions in the input, which can be determined as the local region associated with the neuron. The neurons compute a dot product between the weights of the neurons and the region in the local input to which the neurons are connected. The output from the convolution stage 216 defines a set of linear activations that are processed by successive stages of the convolutional layer 214.

The linear activations can be processed by a detection operation in the convolutional stage 216 (which may alternatively be illustrated as a detector stage). In the detection operation, each linear activation is processed by a non-linear activation function. The non-linear activation function increases the nonlinear properties of the overall network without affecting the receptive fields of the convolution layer. Several types of non-linear activation functions may be used. One particular type is the rectified linear unit (ReLU), which uses an activation function such that the activation is thresholded at zero.

The pooling stage 220 uses a pooling function that replaces the output of the convolutional layer 206 with a summary statistic of the nearby outputs. The pooling function can be used to introduce translation invariance into the neural network, such that small translations to the input do not change the pooled outputs. Invariance to local translation can be useful in scenarios where the presence of a feature in the input data is more important than the precise location of the feature. Various types of pooling functions can be used during the pooling stage 220, including max pooling, average pooling, and 12-norm pooling. Additionally, some CNN implementations do not include a pooling stage. Instead, such implementations substitute and additional convolution stage having an increased stride relative to previous convolution stages.

The output from the convolutional layer 214 can then be processed by the next layer 222. The next layer 222 can be an additional convolutional layer or one of the fully connected layers 208. For example, the first convolutional layer 204 of FIG. 2A can output to the second convolutional layer 206, while the second convolutional layer can output to a first layer of the fully connected layers 208.

In some embodiments, the pooling stage 220 is a dynamic conditional pooling stage that provides for conditional aggregation operation to adaptively aggregate features using a set of learnable convolutional filters, conditional normalization operation to dynamically normalize pooled features, and soft weight generation that is conditional on input samples to regulate the aggregation and normalization operations.

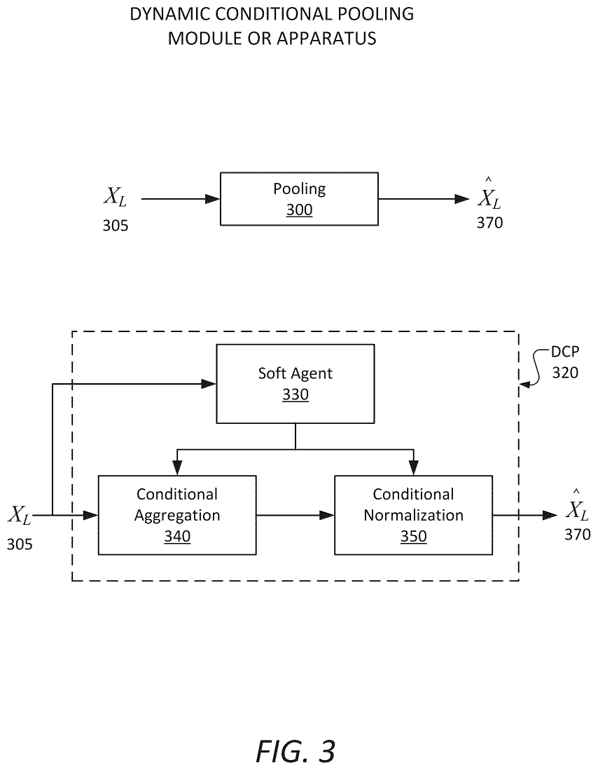

FIG. 3 illustrates an overview of a dynamic conditional pooling (DCP) apparatus or module for deep feature learning, according to some embodiments. As shown in FIG. 3, an operation in an apparatus, system, or process includes receipt of an input sample X_{L} 305, with X_{L} being transformed by a pooling apparatus or module 300 to generate the value \hat{X}_{L} 310.

In some embodiments, a dynamic conditional pooling apparatus or module 320 includes, but is not limited to, a conditional aggregation block 340 for adaptively aggregating features using a set of learnable convolutional filters, a conditional normalization block 350 for dynamically normalizing the pooled features, and a soft agent 330 for generating soft weights conditional on input samples to regulate the aggregation and normalization blocks.

In some embodiments, the DCP apparatus or module 320 provides for: (1) dynamic pooling conditioning both on the input sample (providing sample-aware operation) and feature maps (providing distribution-adaptive operation) at the current layer; (2) weighting individual feature pixels regarding a local map region by a set of learnable compositive importance-unequal kernels; (3) normalizing the aggregated features conditioning on the input sample.

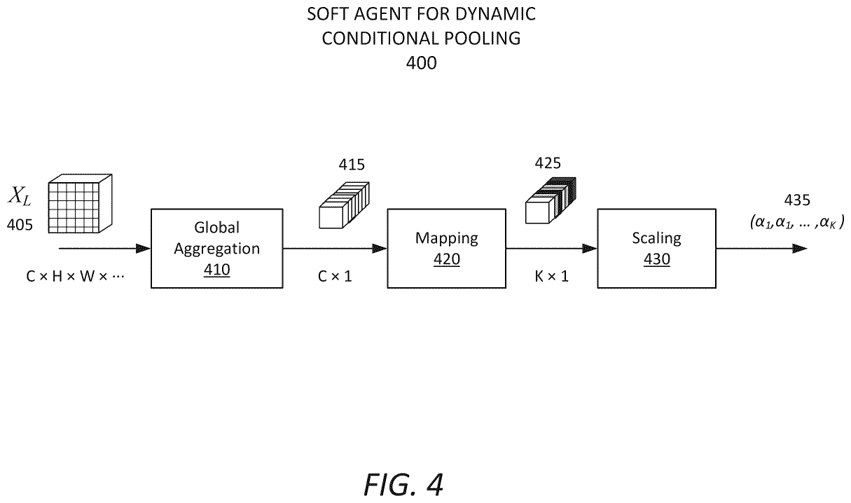

Additional details regarding the conditional aggregation block 340, the conditional normalization block 350, and the soft agent 330 are illustrated in FIGS. 4-8.

Soft Agent

FIG. 4 is an illustration of a soft agent for dynamic conditional pooling, according to some embodiments. In some embodiments, a soft agent is a lightweight block designed to dynamically generate soft weights conditional on the input sample for regulating aggregation and normalization blocks, such as conditional. As used here, a soft weight refers to a weight value that is determined in operation based on certain values or conditions.

FIG. 4 illustrates a soft agent 400, such as the soft agent 330 of the dynamic conditional pooling apparatus or module 320 illustrated in FIG. 3. As shown, the size of input sample X_{L} 405 is indicated as C×H×W× . . . . In some embodiments, a global aggregation block 410 is to aggregate the input sample 405 along all the input dimensions except the first one, resulting in a C-dimensional feature vector 415, shown as C×1.

In some embodiments, the feature vector 415 is then linearly or non-linearly mapped, shown as mapping 420, to generate mapped values 425, shown as K×1. The result then is scaled, shown as scaling 430, to K soft weights 435 (α₁, α₂, . . . , α_{K}), wherein K is the number of the soft weights required by the follow-up regulated blocks.

In some embodiments, the soft agent 400 thus provides easily implementable operations, and can be effectively trained using forward or backward propagation algorithms in deep learning. Further, the soft agent 400 can serve as a general bridge between the entire input sample 405 and local operations.

Conditional Aggregation

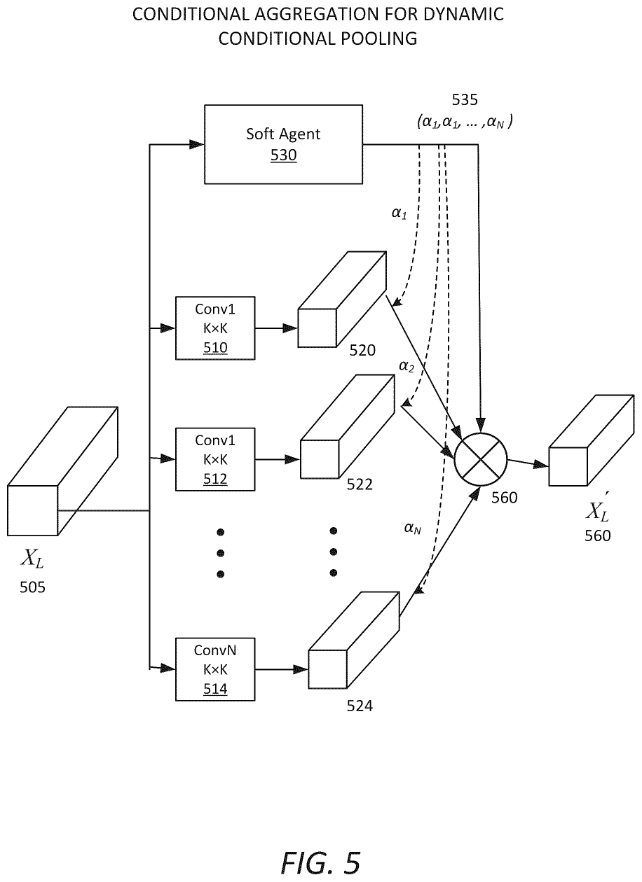

FIG. 5 illustrates conditional aggregation for dynamic conditional pooling, according to some embodiments. In some embodiments, instead of aggregating features using equally, attentionally, or stochastically applied weights as in previous pooling solutions, dynamic conditional pooling is applied to adaptively learn the importance of each feature using a set of convolutional filters with equivalent strides, as shown in FIG. 5. In some embodiments, individual feature pixels are to be weighted regarding a local map region by a set of learnable compositive importance-unequal kernels.

As illustrated in FIG. 5, input sample X_{L} 505 is received, and is directed to a soft agent 530, such as the soft agent 400 illustrated in FIG. 4, and to a plurality of convolutional kernels. In an example, it may be assumed that N convolutional kernels, shown as convolutional kernels Conv1 510, Conv2 512, and continuing through ConvN 514, are utilized, each with size K×K, for the illustrated N convolutional filters 520, 522, and continuing through the Nth value 534. The soft weights 535 generated by the soft agent 530 are denoted as αᵢ, i=1, . . . , N (α₁, α₂, α_{N}), which is illustrated as a particular soft weight for each of the N convolutional filters 520-524. The filter outputs are then weighted by the soft weights 535 in the illustrated convolution operation 550 to generate the aggregated value X_{L}′ 560.

The calculation of the conditional aggregation block thus may be presented as the following:

X_{L}′=∫ᵢ₌₁^{N}αᵢ(X_{L}⊗Wᵢ) [1]

wherein ⊗ is convolutional operation, Wᵢ denotes the weights of the convolutional filter, and X_{L}′ is the resulting aggregated value. The down-sampling property of current pooling operations is provided by striding in convolutional operations. The convolutional filters with equivalent strides as corresponding pooling operations may also be learned using standard deep learning optimization algorithms.

It is noted that softly summing up a set of learnable convolutional filters is theoretically equivalent to using only one convolutional filter. However, the explicit expansion of the convolutional operation provided by this set of convolutional filters enriches and improves the expressiveness of the aggregated features significantly. Further, the cost of using this set of convolutional filters can be naturally optimized when running on deep learning accelerated platforms.

This set of convolutional filters 520-524 causes the aggregation block conditioning on feature maps occurring at the current layer, which illustrates the distribution-adaptive property of the dynamic conditional pooling module. Further, the soft weights corresponding to this set of convolutional filters cause this aggregation block conditioning to occur on the input sample, which illustrates the sample-aware property of the dynamic conditional pooling module.

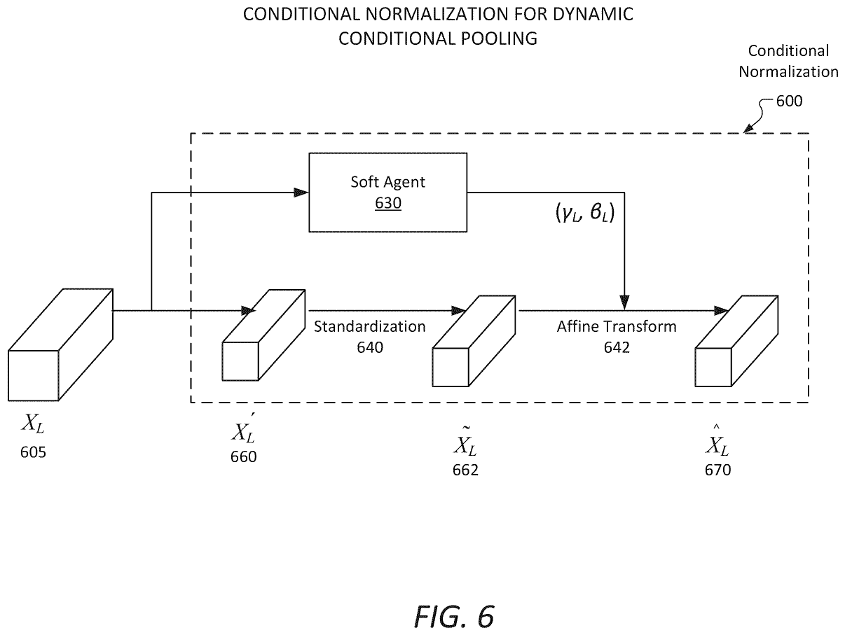

FIG. 6 illustrates conditional normalization for dynamic conditional pooling, according to some embodiments. In some embodiments, a conditional normalization block, such as the conditional normalization block 350 illustrated in FIG. 3, is configured together with the aggregation block to further improve the generality and efficiency of the dynamic conditional pooling module. As shown in FIG. 6, upon the input X_{L} 605 being processed, such as shown in FIG. 5, to generate the aggregated value X_{L}′ 660, this value is then conditionally normalized to generate the output X_{L} 670.

In some embodiments, conditional normalization 600 utilizes conditional computing, as also utilized in the aggregation block processing shown in FIG. 5. In some embodiments, the normalization block includes two processes, standardization 640 and affine transform 642. The affine transform 642 is regulated by the soft agent 630. In this way, the pooling module is an integral conditional computing block.

Denoting the output of conditional aggregation block as aggregated value X_{L}′ 660, the parameters regulating the affine transform that are generated by the soft agent are indicated as (γ_{L}, β_{L}). The standardization procedure then can be expressed as:

$${\tilde{X}}_{L} = \frac{{X}_{L}^{′} - μ}{σ} \qquad [ 2 ]$$

where μ and σ respectively represent mean and standard deviation computed within non-overlapping subsets of the input feature map. Depending on different choices of subsets, the dimensions of μ and σ vary. The standardized representation \tilde{X}_{L} is expected to be in a distribution with zero mean and unit variance. Typically, an affine transform is performed after the standardization stage, which is critical to recover the representation capacity of the original feature map. The affine transform 642 re-scales and re-shifts the standardized feature map with trainable parameters γ and β respectively. In some embodiments, values γ_{L} and β_{L} are to replace γ and β, making the normalization block dynamically conditioning on the input sample. Therefore, the affine transform may be expressed as:

\hat{X}_{L}=γ_{L}\tilde{X}_{L}+β_{L} [3]

It is noted that the number of parameters in the normalization block in an embodiment is the same as that in standard normalization block, except for the parameters of soft agent. In this way, the aggregated features provide normalized conditioning on the input sample.

In contrast with a conventional pooling solution, an embodiment of a dynamic conditional pooling module utilize a set of learnable compositive importance-unequal convolutional kernels to adaptively weight individual feature pixels regarding a local map region, and utilizes a set of learnable soft weights conditioning on specific input sample to adjust the contributions of each convolutional kernel. Benefit of this novel technology include enriching the expressiveness of aggregated features using multiple importance-unequal kernels first, and then using sample-aware conditional computing to effectively fuse the aggregated features. To maintain the advantages of the aggregated features, the dynamic conditional pooling module uses two learnable parameters conditioning on input sample to dynamically adjust the affine transformation in normalization block. This design allows the dynamic conditional pooling to be utilized as a general plug-and-play module that can be integrated into any CNN network architectures, replacing current pooling modules or inserting after convolutional layers where the stride is over to act as an efficient down sampler.

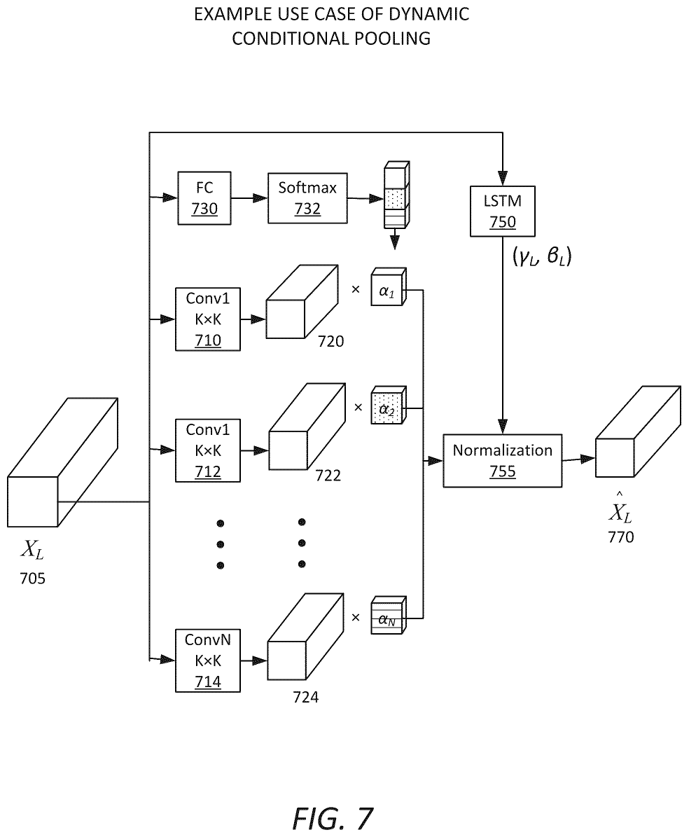

FIG. 7 is an illustration of an example use case of dynamic conditional pooling, according to some embodiments. As illustrated in FIG. 7, input sample X_{L} 705 is received and provided to N convolutional kernels, shown as convolutional kernels Cony 1 710, Conv2 712, and continuing through ConvN 714, each with size K×K, for the illustrated N convolutional filters 720, 722, and continuing through the Nth value 734. The soft weights 535 generated by the soft agent 530 are denoted as αᵢ, i=1, . . . , N (α₁, α₂, . . . , α_{N}), which is illustrated as a particular soft weight for each of the N convolutional filters 520-524.

In some embodiments, two soft agents are implemented to provide conditional aggregation and conditional normalization blocks separately. As illustrated in FIG. 7, for the conditional aggregation block, a first soft agent includes global average pooling (GAP) 707 for global aggregation, a fully-connected (FC) layer 730 with N output units for mapping, and a SoftMax layer 732 for scaling. This may be expressed as:

(α₁,α₂, . . . ,α_{N})=SoftMax(FC(GAP(X_{L}))) [4]

In some embodiments, for the conditional normalization block, a second soft agent again includes the global average pooling (GAP) 707 for global aggregation, and further includes a long short-term memory (LSTM) block 750 (LSTM referring to an RNN architecture) included to provide mapping and scaling:

(γ_{L},β_{L})=LSTM(GAP(X_{L}),γ_{L}′,β_{L}′) [5]

For conditional aggregation and normalization, the provisions of Eq. [1]-[3] may apply. When using batch-based normalization, μ and σ in Eq. [2] are C-dimensional vectors calculated for each channel. Further, γ_{L} and β_{L} in Eq. [3] are also C-dimensional vectors learned by the soft agent.

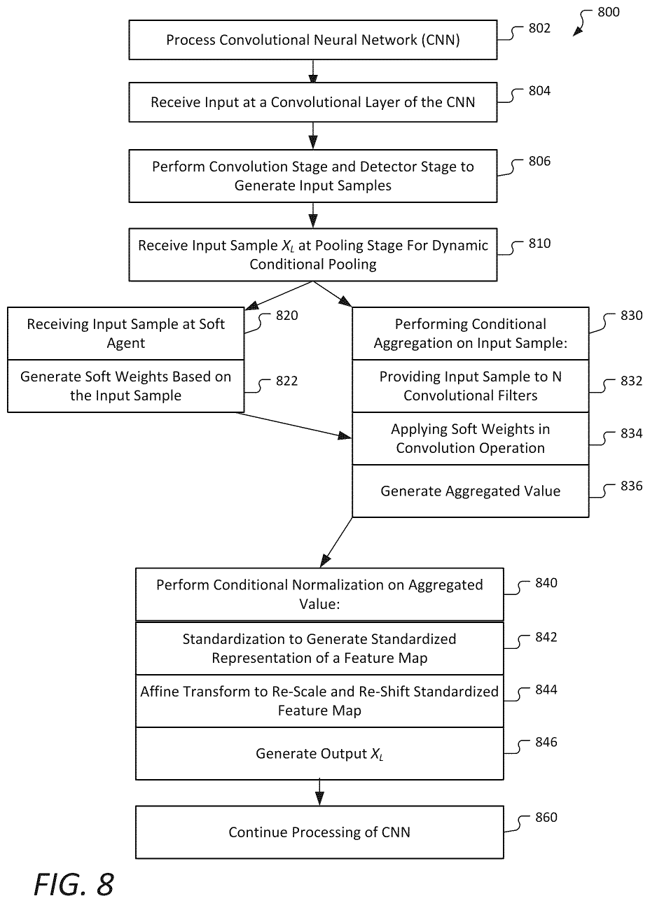

FIG. 8 is a flowchart to illustrate dynamic conditional pooling, according to some embodiments. As illustrated in FIG. 8, a process 900 includes processing of a convolutional neural network (CNN) 802. In such processing of the CNN, an input is received at a convolutional layer 804. In some embodiments, the processing includes performing convolution and detection operations, such as illustrated in stage 216 of convolutional layer 214, to generate input samples 806.

In some embodiments, an input sample X_{L} is received at a pooling stage to perform dynamic conditional pooling 810, the dynamic conditional pooling stage provides for conditional aggregation operation to adaptively aggregate features using a set of learnable convolutional filters, conditional normalization operation to dynamically normalize pooled features, and soft weight generation that is conditional on input samples to regulate the aggregation and normalization operations. including:
Receiving the input sample at a soft agent 820. In some embodiments, the soft agent is to generate soft weights (α₁, α₂, . . . , α_{N}) based on the input sample 822, utilizing global aggregation, mapping, and scaling, as further illustrated in FIG. 4.
Performing conditional aggregation on the received input sample 830, including providing the input sample to N convolutional filters 932, and applying the generated soft weights (α₁, α₂, . . . , α_{N}) in a convolution operation 934 and generate an aggregated value X_{L}′ 936.

Performing conditional normalization of the aggregated value X_{L}′ 840, including performing standardization to generate a standardized representation X_{L} 842, and performing an affine transform to re-scale and re-shift the standardized feature map 844, the affine transform using trainable parameters produced by the soft agent, to generate the output X_{L} 846.

The process is then to continue with processing of the CNN 860, which may include additional processing of convolutional layers.

FIG. 9 is a schematic diagram of an illustrative electronic computing device to enable dynamic conditional pooling in a convolutional neural network, according to some embodiments. In some embodiments, an example computing device 900 includes one or more processors 910 including one or more processors cores 918. In some embodiments, the computing device is to provide for dynamic conditional pooling in a convolutional neural network, as further illustrated in FIGS. 1-8.

The computing device 900 further includes memory, which may include read-only memory (ROM) 942 and random access memory (RAM) 946. A portion of the ROM 942 may be used to store or otherwise retain a basic input/output system (BIOS) 944. The BIOS 944 provides basic functionality to the computing device 900, for example by causing the processor cores 918 to load and/or execute one or more machine-readable instruction sets 914. In embodiments, at least some of the one or more machine-readable instruction sets 914 cause at least a portion of the processor cores 918 to process and to process data, including data for a convolutional neural network (CNN) 915. In some embodiments, the CNN processing includes dynamic conditional pooling (DCP) processing that provides for a conditional aggregation operation to adaptively aggregate features using a set of learnable convolutional filters, conditional a normalization operation to dynamically normalize pooled features, and soft weight generation that is conditional on input samples to regulate the aggregation and normalization operations. In some embodiments, the one or more instruction sets 914 may be stored in one or more data storage devices 960, wherein the processor cores 918 are capable of reading data and/or instruction sets 914 from one or more non-transitory data storage devices 960 and writing data to the one or more data storage devices 960.

Computing device 900 is a particular example of a processor based device. Those skilled in the relevant art will appreciate that the illustrated embodiments as well as other embodiments may be practiced with other processor-based device configurations, including portable electronic or handheld electronic devices, for instance smartphones, portable computers, wearable computers, consumer electronics, personal computers (“PCs”), network PCs, minicomputers, server blades, mainframe computers, and the like.

The example computing device 900 may be implemented as a component of another system such as, for example, a mobile device, a wearable device, a laptop computer, a tablet, a desktop computer, a server, etc. In one embodiment, computing device 900 includes or can be integrated within (without limitation): a server-based gaming platform; a game console, including a game and media console; a mobile gaming console, a handheld game console, or an online game console. In some embodiments the computing device 900 is part of a mobile phone, smart phone, tablet computing device or mobile Internet-connected device such as a laptop with low internal storage capacity. In some embodiments the computing device 900 is part of an Internet-of-Things (IoT) device, which are typically resource-constrained devices. IoT devices may include embedded systems, wireless sensor networks, control systems, automation (including home and building automation), and other devices and appliances (such as lighting fixtures, thermostats, home security systems and cameras, and other home appliances) that support one or more common ecosystems, and can be controlled via devices associated with that ecosystem, such as smartphones and smart speakers.

Computing device 900 can also include, couple with, or be integrated within: a wearable device, such as a smart watch wearable device; smart eyewear or clothing enhanced with augmented reality (AR) or virtual reality (VR) features to provide visual, audio or tactile outputs to supplement real world visual, audio or tactile experiences or otherwise provide text, audio, graphics, video, holographic images or video, or tactile feedback; other augmented reality (AR) device; or other virtual reality (VR) device. In some embodiments, the computing device 900 includes or is part of a television or set top box device. In one embodiment, computing device 900 can include, couple with, or be integrated within a self-driving vehicle such as a bus, tractor trailer, car, motor or electric power cycle, plane or glider (or any combination thereof). The self-driving vehicle may use computing system 900 to process the environment sensed around the vehicle.

The computing device 900 may additionally include one or more of the following: a memory cache 920, a graphical processing unit (GPU) 912 (which may be utilized as a hardware accelerator in some implementations), a wireless input/output (I/O) interface 925, a wired I/O interface 930, power management circuitry 950, an energy storage device (such as a battery, a connection to external power source, and a network interface 970 for connection to a network 972. The following discussion provides a brief, general description of the components forming the illustrative computing device 900. Example, non-limiting computing devices 900 may include a desktop computing device, blade server device, workstation, or similar device or system.

The processor cores 918 may include any number of hardwired or configurable circuits, some or all of which may include programmable and/or configurable combinations of electronic components, semiconductor devices, and/or logic elements that are disposed partially or wholly in a PC, server, or other computing system capable of executing processor-readable instructions.

The computing device 900 includes a bus or similar communications link 916 that communicably couples and facilitates the exchange of information and/or data between the various system components. The computing device 900 may be referred to in the singular herein, but this is not intended to limit the embodiments to a single computing device 900, since in certain embodiments, there may be more than one computing device 900 that incorporates, includes, or contains any number of communicably coupled, collocated, or remote networked circuits or devices.

The processor cores 918 may include any number, type, or combination of currently available or future developed devices capable of executing machine-readable instruction sets.

The processor cores 918 may include (or be coupled to) but are not limited to any current or future developed single- or multi-core processor or microprocessor, such as: one or more systems on a chip (SOCs); central processing units (CPUs); digital signal processors (DSPs); graphics processing units (GPUs); application-specific integrated circuits (ASICs), programmable logic units, field programmable gate arrays (FPGAs), and the like. Unless described otherwise, the construction and operation of the various blocks shown in FIG. 9 are of conventional design. Consequently, such blocks need not be described in further detail herein, as they will be understood by those skilled in the relevant art. The bus 916 that interconnects at least some of the components of the computing device 900 may employ any currently available or future developed serial or parallel bus structures or architectures.

The at least one wireless I/O interface 925 and at least one wired I/O interface 930 may be communicably coupled to one or more physical output devices (tactile devices, video displays, audio output devices, hardcopy output devices, etc.). The interfaces may be communicably coupled to one or more physical input devices (pointing devices, touchscreens, keyboards, tactile devices, etc.). The at least one wireless I/O interface 925 may include any currently available or future developed wireless I/O interface. Examples of wireless I/O interfaces include, but are not limited to Bluetooth®, near field communication (NFC), and similar. The wired I/O interface 930 may include any currently available or future developed I/O interface. Examples of wired I/O interfaces include, but are not limited to universal serial bus (USB), IEEE 1394 (“FireWire”), and similar.

The data storage devices 960 may include one or more hard disk drives (HDDs) and/or one or more solid-state storage devices (SSDs). The one or more data storage devices 960 may include any current or future developed storage appliances, network storage devices, and/or systems. Non-limiting examples of such data storage devices 960 may include, but are not limited to, any current or future developed non-transitory storage appliances or devices, such as one or more magnetic storage devices, one or more optical storage devices, one or more electro-resistive storage devices, one or more molecular storage devices, one or more quantum storage devices, or various combinations thereof. In some implementations, the one or more data storage devices 960 may include one or more removable storage devices, such as one or more flash drives, flash memories, flash storage units, or similar appliances or devices capable of communicable coupling to and decoupling from the computing device 900.

The one or more data storage devices 960 may include interfaces or controllers (not shown) communicatively coupling the respective storage device or system to the bus 916. The one or more data storage devices 960 may store, retain, or otherwise contain machine-readable instruction sets, data structures, program modules, data stores, databases, logical structures, and/or other data useful to the processor cores 918 and/or graphics processor circuitry 912 and/or one or more applications executed on or by the processor cores 918 and/or graphics processor circuitry 912. In some instances, one or more data storage devices 960 may be communicably coupled to the processor cores 918, for example via the bus 916 or via one or more wired communications interfaces 930 (e.g., Universal Serial Bus or USB); one or more wireless communications interfaces 925 (e.g., Bluetooth®, Near Field Communication or NFC); and/or one or more network interfaces 970 (IEEE 802.3 or Ethernet, IEEE 802.11, or Wi-Fi®, etc.).

Processor-readable instruction sets 914 and other programs, applications, logic sets, and/or modules may be stored in whole or in part in the system memory 940. Such instruction sets 914 may be transferred, in whole or in part, from the one or more data storage devices 960. The instruction sets 914 may be loaded, stored, or otherwise retained in system memory 940, in whole or in part, during execution by the processor cores 918 and/or graphics processor circuitry 912.

In embodiments, the energy storage device 952 may include one or more primary (i.e., non-rechargeable) or secondary (i.e., rechargeable) batteries or similar energy storage devices. In embodiments, the energy storage device 952 may include one or more supercapacitors or ultracapacitors. In embodiments, the power management circuitry 950 may alter, adjust, or control the flow of energy from an external power source 954 to the energy storage device 952 and/or to the computing device 900. The power source 954 may include, but is not limited to, a solar power system, a commercial electric grid, a portable generator, an external energy storage device, or any combination thereof.

For convenience, the processor cores 918, the graphics processor circuitry 912, the wireless I/O interface 925, the wired I/O interface 930, the data storage device 960, and the network interface 970 are illustrated as communicatively coupled to each other via the bus 916, thereby providing connectivity between the above-described components. In alternative embodiments, the above-described components may be communicatively coupled in a different manner than illustrated in FIG. 9. For example, one or more of the above-described components may be directly coupled to other components, or may be coupled to each other, via one or more intermediary components (not shown). In another example, one or more of the above-described components may be integrated into the processor cores 918 and/or the graphics processor circuitry 912. In some embodiments, all or a portion of the bus 916 may be omitted and the components are coupled directly to each other using suitable wired or wireless connections.

The machine readable instructions described herein may be stored in one or more of a compressed format, an encrypted format, a fragmented format, a compiled format, an executable format, a packaged format, etc. Machine readable instructions as described herein may be stored as data (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers). The machine readable instructions may utilize one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement a program such as that described herein.

In another example, the machine readable instructions may be stored in a state in which they may be read by a computer, but utilize addition of a library (e.g., a dynamic link library (DLL)), a software development kit (SDK), an application programming interface (API), etc. in order to execute the instructions on a particular computing device or other device. In another example, the machine readable instructions may be configured (e.g., settings stored, data input, network addresses recorded, etc.) before the machine readable instructions and/or the corresponding program(s) can be executed in whole or in part. Thus, the disclosed machine readable instructions and/or corresponding program(s) are intended to encompass such machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example processes of FIG. 8 and other described processes may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended.

The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

Descriptors “first,” “second,” “third,” etc. are used herein when identifying multiple elements or components which may be referred to separately. Unless otherwise specified or understood based on their context of use, such descriptors are not intended to impute any meaning of priority, physical order, or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

The following examples pertain to further embodiments.

In Example 1, one or more non-transitory computer-readable storage mediums have stored thereon instructions that, when executed by one or more processors, cause the one or more processors to perform operations comprising receiving an input at a convolutional layer of a convolutional neural network (CNN); receiving an input sample at a pooling stage of the convolutional layer; generating a plurality of soft weights based on the input sample; performing conditional aggregation on the input sample utilizing the plurality of soft weights to generate an aggregated value; and performing conditional normalization on the aggregated value to generate an output for the convolutional layer.

In Example 2, the plurality of soft weights are generated by at least one soft agent.

In Example 3, the at least one soft agent is to perform global aggregation of the input sample to aggregate the input sample along all but one input dimensions; mapping of the aggregated input sample; and scaling of the mapped input sample to generate the plurality of soft weights.

In Example 4, the at least one soft agent includes a first soft agent to support the conditional aggregation and a second soft agent to support the conditional normalization.

In Example 5, the first soft agent includes a fully connected layer for mapping and a layer for scaling.

In Example 6, the second soft agent includes a long short-term memory (LSTM) block to provide mapping and scaling.

In Example 7, performing the conditional aggregation includes receiving the input sample at a plurality of convolutional kernels for a plurality of convolutional filters; and weighting an output of each of the convolutional filters with a respective soft weight of the plurality of soft weights.

In Example 8, performing the conditional normalization includes performing standardization to generate a standardized representation of a feature map; and performing an affine transform to re-scale and re-shift the standardized feature map.

In Example 9, the instructions, when executed, further cause the one or more processors to perform operations including performing convolution and detection to generate the input sample from the input received at the convolutional layer.

In Example 10, an apparatus includes one or more processors; and a memory to store data, including data of a convolutional neural network (CNN), the CNN having a plurality of layers including one or more convolutional layers, wherein the one or more processors are to receive an input at a first convolutional layer of the CNN and generate an input sample from the input; receive an input sample at a pooling stage of the first convolutional layer; generate a plurality of soft weights based on the input sample; perform conditional aggregation on the input sample utilizing the plurality of soft weights to generate an aggregated value; and perform conditional normalization on the aggregated value to generate an output for the convolutional layer.

In Example 11, the plurality of soft weights are generated by at least one soft agent.

In Example 12, the at least one soft agent is to perform global aggregation of the input sample to aggregate the input sample along all but one input dimensions; mapping of the aggregated input sample; and scaling of the mapped input sample to generate the plurality of soft weights.

In Example 13, the at least one soft agent includes a first soft agent to support the conditional aggregation and a second soft agent to support the conditional normalization.

In Example 14, performing the conditional aggregation includes receiving the input sample at a plurality of convolutional kernels for a plurality of convolutional filters; and weighting an output of each of the convolutional filters with a respective soft weight of the plurality of soft weights.

In Example 15, performing the conditional normalization includes performing standardization to generate a standardized representation of a feature map; and performing an affine transform to re-scale and re-shift the standardized feature map.

In Example 16, wherein the one or more processors are further to perform convolution and detection to generate the input sample from the input received at the convolutional layer.

In Example 17, a computing system includes one or more processors; a data storage to store data including instructions for the one or more processors; and a memory including random access memory (RAM) to store data, including data of a convolutional neural network (CNN), the CNN having a plurality of layers including one or more convolutional layers, wherein the computing system is to receive an input at a first convolutional layer of the CNN and generate an input sample from the input; receive an input sample at a pooling stage of the first convolutional layer; generate a plurality of soft weights based on the input sample, wherein the plurality of soft weights are generated by at least one soft agent; perform conditional aggregation on the input sample utilizing the plurality of soft weights to generate an aggregated value; and perform conditional normalization on the aggregated value to generate an output for the convolutional layer.

In Example 18, the at least one soft agent is to perform global aggregation of the input sample to aggregate the input sample along all but one input dimensions; mapping of the aggregated input sample; and scaling of the mapped input sample to generate the plurality of soft weights.

In Example 19, performing the conditional aggregation includes receiving the input sample at a plurality of convolutional kernels for a plurality of convolutional filters; and weighting an output of each of the convolutional filters with a respective soft weight of the plurality of soft weights.

In Example 20, performing the conditional normalization includes performing standardization to generate a standardized representation of a feature map; and performing an affine transform to re-scale and re-shift the standardized feature map.

In Example 21, an apparatus includes means for receiving an input at a convolutional layer of a convolutional neural network (CNN); means for receiving an input sample at a pooling stage of the convolutional layer; means for generating a plurality of soft weights based on the input sample; means for performing conditional aggregation on the input sample utilizing the plurality of soft weights to generate an aggregated value; and means for performing conditional normalization on the aggregated value to generate an output for the convolutional layer.

In Example 22, the plurality of soft weights are generated by at least one soft agent.

In Example 23, the at least one soft agent is to perform global aggregation of the input sample to aggregate the input sample along all but one input dimensions; mapping of the aggregated input sample; and scaling of the mapped input sample to generate the plurality of soft weights.

In Example 24, the at least one soft agent includes a first soft agent to support the conditional aggregation and a second soft agent to support the conditional normalization.

In Example 25, the first soft agent includes a fully connected layer for mapping and a layer for scaling.

In Example 26, the second soft agent includes a long short-term memory (LSTM) block to provide mapping and scaling.

In Example 27, the means for performing the conditional aggregation includes means for receiving the input sample at a plurality of convolutional kernels for a plurality of convolutional filters; and means for weighting an output of each of the convolutional filters with a respective soft weight of the plurality of soft weights.

In Example 28, the means for performing the conditional normalization includes means for performing standardization to generate a standardized representation of a feature map; and means for performing an affine transform to re-scale and re-shift the standardized feature map.

In Example 29, the apparatus further includes means for performing convolution and detection to generate the input sample from the input received at the convolutional layer.

Specifics in the Examples may be used anywhere in one or more embodiments.

The foregoing description and drawings are to be regarded in an illustrative rather than a restrictive sense. Persons skilled in the art will understand that various modifications and changes may be made to the embodiments described herein without departing from the broader spirit and scope of the features set forth in the appended claims.

What is claimed is:

1. One or more non-transitory computer-readable storage mediums having stored thereon instructions that, when executed by one or more processors, cause the one or more processors to perform operations comprising:
receiving an input at a convolutional layer of a convolutional neural network (CNN);
receiving an input sample at a pooling stage of the convolutional layer;
generating a plurality of soft weights based on the input sample;
performing conditional aggregation on the input sample utilizing the plurality of soft weights to generate an aggregated value; and
performing conditional normalization on the aggregated value to generate an output for the convolutional layer.

2. The medium of claim 1, wherein the plurality of soft weights are generated by at least one soft agent.

3. The medium of claim 2, wherein the at least one soft agent is to perform:
global aggregation of the input sample to aggregate the input sample along all but one input dimensions;
mapping of the aggregated input sample; and
scaling of the mapped input sample to generate the plurality of soft weights.

4. The medium of claim 3, wherein the at least one soft agent includes a first soft agent to support the conditional aggregation and a second soft agent to support the conditional normalization.

5. The medium of claim 4, wherein the first soft agent includes a fully connected layer for mapping and a layer for scaling.

6. The medium of claim 4, wherein the second soft agent includes a long short-term memory (LSTM) block to provide mapping and scaling.

7. The medium of claim 1, wherein performing the conditional aggregation includes:
receiving the input sample at a plurality of convolutional kernels for a plurality of convolutional filters; and
weighting an output of each of the convolutional filters with a respective soft weight of the plurality of soft weights.

8. The medium of claim 1, wherein performing the conditional normalization includes:
performing standardization to generate a standardized representation of a feature map; and
performing an affine transform to re-scale and re-shift the standardized feature map.

9. The medium of claim 1, wherein the instructions, when executed, further cause the one or more processors to perform operations comprising:
performing convolution and detection to generate the input sample from the input received at the convolutional layer.

10. An apparatus comprising:
one or more processors; and
a memory to store data, including data of a convolutional neural network (CNN), the CNN having a plurality of layers including one or more convolutional layers, wherein the one or more processors are to:
receive an input at a first convolutional layer of the CNN and generate an input sample from the input;
receive an input sample at a pooling stage of the first convolutional layer;
generate a plurality of soft weights based on the input sample;
perform conditional aggregation on the input sample utilizing the plurality of soft weights to generate an aggregated value; and
perform conditional normalization on the aggregated value to generate an output for the convolutional layer.

11. The apparatus of claim 10, wherein the plurality of soft weights are generated by at least one soft agent.

12. The apparatus of claim 11, wherein the at least one soft agent is to perform:
global aggregation of the input sample to aggregate the input sample along all but one input dimensions;
mapping of the aggregated input sample; and
scaling of the mapped input sample to generate the plurality of soft weights.

13. The apparatus of claim 12, wherein the at least one soft agent includes a first soft agent to support the conditional aggregation and a second soft agent to support the conditional normalization.

14. The apparatus of claim 10, wherein performing the conditional aggregation includes:
receiving the input sample at a plurality of convolutional kernels for a plurality of convolutional filters; and
weighting an output of each of the convolutional filters with a respective soft weight of the plurality of soft weights.

15. The apparatus of claim 10, wherein performing the conditional normalization includes:
performing standardization to generate a standardized representation of a feature map; and
performing an affine transform to re-scale and re-shift the standardized feature map.

16. The apparatus of claim 10, wherein the one or more processors are further to:
perform convolution and detection to generate the input sample from the input received at the convolutional layer.

17. A computing system comprising:
one or more processors;
a data storage to store data including instructions for the one or more processors; and
a memory including random access memory (RAM) to store data, including data of a convolutional neural network (CNN), the CNN having a plurality of layers including one or more convolutional layers, wherein the computing system is to:
receive an input at a first convolutional layer of the CNN and generate an input sample from the input;
receive an input sample at a pooling stage of the first convolutional layer;
generate a plurality of soft weights based on the input sample, wherein the plurality of soft weights are generated by at least one soft agent;
perform conditional aggregation on the input sample utilizing the plurality of soft weights to generate an aggregated value; and
perform conditional normalization on the aggregated value to generate an output for the convolutional layer.

18. The computing system of claim 17, wherein the at least one soft agent is to perform:
global aggregation of the input sample to aggregate the input sample along all but one input dimensions;
mapping of the aggregated input sample; and
scaling of the mapped input sample to generate the plurality of soft weights.

19. The computing system of claim 17, wherein performing the conditional aggregation includes:
receiving the input sample at a plurality of convolutional kernels for a plurality of convolutional filters; and
weighting an output of each of the convolutional filters with a respective soft weight of the plurality of soft weights.

20. The computing system of claim 17, wherein performing the conditional normalization includes:
performing standardization to generate a standardized representation of a feature map; and
performing an affine transform to re-scale and re-shift the standardized feature map.
